(19) United States
(12) Patent Application Publication
(10) Pub. No.: US 2015/0192158 A1
(43) Pub. Date: Jul. 9, 2015

(54) Lock Hole Mechanism

(71) Applicant: Acer Inc., New Taipei City (TW)

(72) Inventor: Chia-Bo Chen, New Taipei City (TW)

(21) Appl. No.: 14/307,529

(22) Filed: Jun. 18, 2014

(30) Foreign Application Priority Data
Jan. 7, 2014 (TW) 103100494

(51) Int. Cl. F16B 9/02

(52) U.S. Cl. CPC F16B 9/026

(57) ABSTRACT

A lock hole mechanism is disclosed. The lock hole mechanism is mounted on an object and includes a main body and a connecting member. The main body includes a lock hole. One end of the connecting member is connected to the object, and the other end of the connecting member is connected to the main body. The thickness of the connecting member is smaller than the thickness of the main body, and the connecting member is flexible.

### BACKGROUND OF THE INVENTION

1. Field of the Invention

The present invention relates to a lock hole mechanism, and in particular to a lock hole mechanism whose connecting part is provided between a main body and an object. The lock hole mechanism can be bent repeatedly.

2. Description of the Related Art

The current design of notebook computers often uses an embedded battery. Unlike with traditional external batteries, the overall thickness of a notebook computer can be reduced by using an embedded battery. Currently, most embedded batteries are fixed to the casing of the notebook computer utilizing a screw locking method.

The casing of each model of notebook computer has different form factors, one being the bending degree of a chamfered corner at the position where a bottom wall connects to a side wall of the casing. Accordingly, the height between a stud located at the chamfered corners for being combined with a screw and the bottom walls varies depending on the model of the notebook computer. Additionally, in order to optimize the space allocation of the casing, when the studs are located at the chamfered corners, the heights of the studs not located at the chamfered corners are different from the heights of the studs located at the chamfered corners. The batteries are disposed on the casing at a specific oblique angle so that there is still enough space to dispose other objects above the batteries. In order to fully lock the screw onto the stud, the lock hole mechanism connecting with the batteries has to be bent corresponding to the battery so as to comply with the oblique angle. As mentioned above, in different casing designs, the heights between the studs at the chamfered corners and the casing bottom wall vary. Accordingly, the oblique angles at which the batteries are disposed are different. Thus, a lock hole mechanism with a fixed bending angle cannot be generally applied to and shared among different models of notebook computers.

### SUMMARY OF THE INVENTION

The objective of the present invention is to provide a lock hole mechanism whose connecting part between a main body of the lock hole mechanism and an object can be bent repeatedly such that the bending angle between the object and the lock hole mechanism can be flexibly adjusted.

In order to achieve the above objectives, the lock hole mechanism of the present invention is installed on an object for fixing the object to a casing when the lock hole mechanism is combined with a locating column of the casing via a fixing component. The lock hole mechanism comprises a main body and a connecting member. The main body includes a lock hole provided for the fixing component to pass through. One end of the connecting member is connected with the object, and the other end of the connecting member is connected with the main body, wherein the thickness of the connecting member is smaller than the thickness of the main body, and the connecting member is flexible, such that the connecting member is used for aligning the lock hole and the locating column.

According to an embodiment of the present invention, the lock hole mechanism of the present invention is made of polypropylene materials.

According to an embodiment of the present invention, the thickness of the connecting member first gradually decreases from the end connecting with the object to the middle of the connecting member, and then the thickness of the connecting member gradually increases from the middle of the connecting member to the end connecting with the main body of the connecting member.

According to an embodiment of the present invention, the connecting member includes an upper surface and a lower surface, the lower surface being a concave surface.

According to an embodiment of the present invention, the minimum thickness of the connecting member is X which satisfies following equation:

0.2≦X≦0.3 mm.

### BRIEF DESCRIPTION OF THE DRAWINGS

These and other objects and advantages of the present invention will become apparent from the following descriptions of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is a top view of a lock hole mechanism according to the present invention;

FIG. 2 is a side schematic diagram of the lock hole mechanism of the present invention locked to an object disposed at an oblique angle;

FIG. 3 is an enlarged side schematic diagram of the lock hole mechanism according to the present invention; and

FIG. 4 is a side schematic diagram of the lock hole mechanism of the present invention locked to an object disposed horizontally.

### DETAILED DESCRIPTION OF THE PREFERRED EMBODIMENT

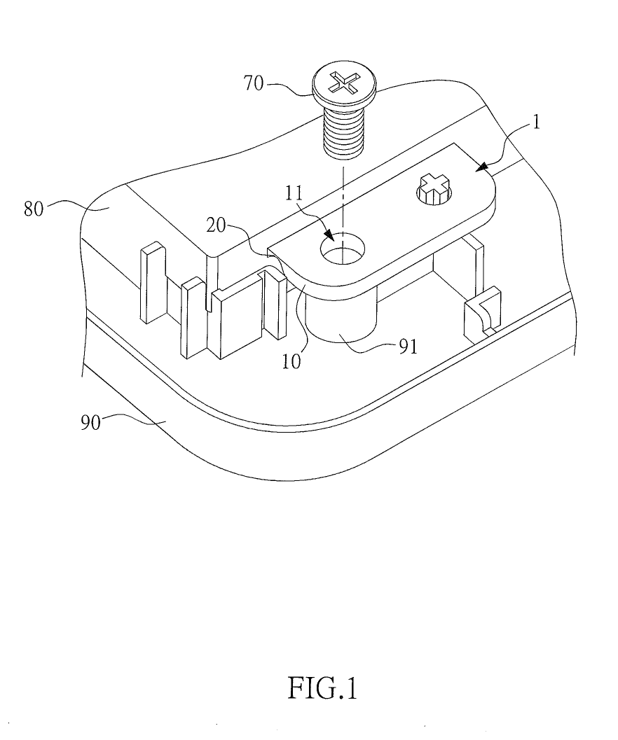

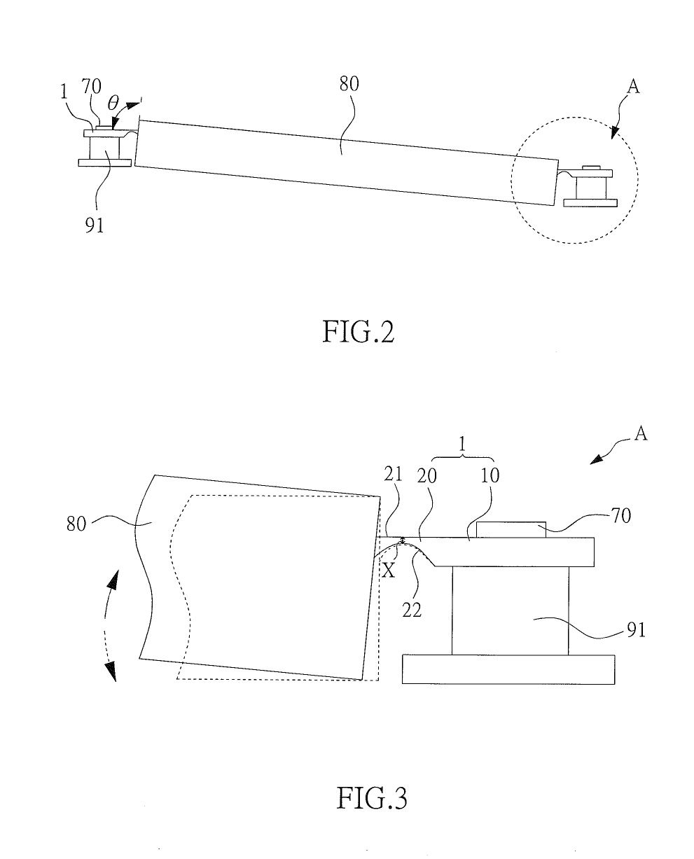

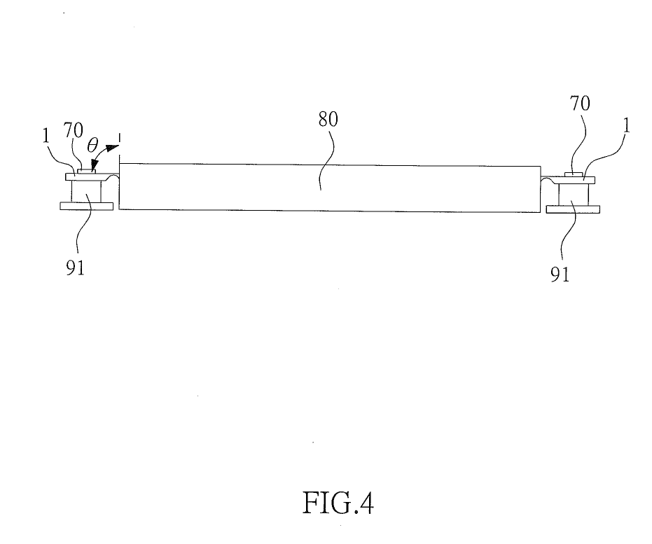

Please refer to FIG. 1 to FIG. 4. FIG. 1 is a top view of a lock hole mechanism according to the present invention; FIG. 2 is a side schematic diagram of the lock hole mechanism of the present invention locked to an object disposed at an angle θ; FIG. 3 is an enlarged side schematic diagram of the lock hole mechanism according to the present invention; and FIG. 4 is a side schematic diagram of the lock hole mechanism of the present invention locked to an object disposed horizontally.

As shown in FIG. 1, the lock hole mechanism 1 of the present invention is installed on an object 80. In an embodiment of the present invention, the object 80 is an embedded battery, but the scope of the present invention is not limited thereto. The lock hole mechanism 1 is used for fixing the object 80 on a casing 90 when a user utilizes a fixing component 70 for combining the lock hole mechanism 1 with a locating column 91 of the casing 90. In the embodiment of the present invention, the locating column 91 includes a screw hole (not shown in the diagrams), and the fixing component 70 is a screw for being combined with the screw hole, but the scope of the present invention is not limited thereto. In an embodiment of the present invention, the lock hole mechanism 1 comprises a main body 10 and a connecting member 20.

In an embodiment of the present invention, the main body 10 includes a lock hole 11, the lock hole being provided for the fixing component to pass through.

As shown in FIG. 2 and FIG. 3, in an embodiment of the present invention, one end of the connecting member 20 is connected to the object 80, and the other end of the connecting member 20 is connected to the main body 10. The connecting member 20 is flexible such that the lock hole mechanism 1 or the object can be moved (as the arrow shown in FIG. 3) such that the lock hole 11 is aligned with the locating column 91. In an embodiment of the present invention, the thickness of the connecting member 20 is less than the thickness of the main body 10. The thickness of the connecting member 20 first gradually decreases from the end connecting the object 80 to the middle of the connecting member, and then the thickness of the connecting member 20 gradually increases from the middle of the connecting member 20 to the other end connecting with the main body 10, wherein the minimum thickness X of the connecting member 20 is 0.2-0.3 mm. The partially unequal design of the thickness makes it easier to bend the lock hole mechanism 1 and makes it convenient for the user to adjust the bending angle.

In an embodiment of the present invention, the lock hole mechanism 1 is made of polypropylene materials. Polypropylene materials are materials of low stiffness and high shock resistance. Accordingly, providing that the thickness of the material is low, Polypropylene materials do not fracture as a result of bending. Additionally, as shown in FIG. 3, the connecting member 20 includes an upper surface 21 and a lower surface 22, and the lower surface 22 is a concave surface (which forms a curve from a side view). The curving structure design reduces the stress that accumulates at the bending part in the middle of the connecting member 20 and further increases the durability in use.

In the lock hole mechanism 1 of the present invention, the connecting member 20 connected to the main body 10 and the object 80 is flexible, which is useful for making corresponding adjustments according to the angle between the object 80 and the bottom wall of the casing when the object 80 is disposed, and which makes the lock hole mechanism 1 applicable to multiple models of casings. For example, as shown in FIG. 1 and FIG. 4, when the object 80 is disposed horizontally, the angle θ between the upper surface 21 on the connecting member 20 of the lock hole mechanism 1 and the object 80 is about 90 degrees. If the object 80 must be disposed at other none-horizontal modes, such as shown in FIG. 2, the lock hole mechanism 1 can be bent downwards (0 larger than 90 degrees) such that the lock hole 11 of the lock hole mechanism 1 aligns with the screw hole of the locating column 91, such that the fixing component 70 can be locked into the screw hole vertically.

While the present invention has been particularly shown and described with reference to a preferred embodiment, it will be understood by those skilled in the art that various changes and modifications can be made to the described embodiment. It is intended to include all such variations, modifications and equivalents which fall within the scope of the invention, as defined in the accompanying claims. It is to be understood that many other possible modifications and variations can be made without departing from the spirit and scope of the invention as hereinafter claimed.

What is claimed is:

1. A lock hole mechanism installed on an object for fixing the object to a casing when the lock hole mechanism is combined with a locating column of the casing utilizing a fixing component, the lock hole mechanism comprising:
a main body including a lock hole provided for the fixing component to pass through; and
a connecting member, one end of the connecting member being connected to the object, and the other end of the connecting member being connected to the main body, wherein the thickness of the connecting member is smaller than the thickness of the main body, and the connecting member is flexible, such that the connecting member can be used for aligning the lock hole and the locating column.

2. The lock hole mechanism as claimed in claim 1, wherein the lock hole mechanism is made of polypropylene materials.

3. The lock hole mechanism as claimed in claim 2, wherein the thickness of the connecting member gradually decreases from the end connecting with the object of the connecting member to the middle of the connecting member, and the thickness of the connecting member gradually increases from the middle of the connecting member to the end connecting with the main body of the connecting member.

4. The lock hole mechanism as claimed in claim 3, wherein the connecting member includes an upper surface and a lower surface, and the lower surface is a concave surface.

5. The lock hole mechanism as claimed in claim 4, wherein the minimum thickness of the connecting member satisfies following equation of 0.2 mm≦X≦0.3 mm.

6. The lock hole mechanism as claimed in claim 1, wherein the thickness of the connecting member first gradually decreases from the end connecting with the object of the connecting member to the middle of the connecting member, and then the thickness of the connecting member gradually increases from the middle of the connecting member to the end connecting with the main body of the connecting member.

7. The lock hole mechanism as claimed in claim 1, wherein the connecting member includes an upper surface and a lower surface, and the lower surface is a concave surface.
